(19) United States
(12) Patent Application Publication
(10) Pub. No.: US 2024/0217831 A1
(43) Pub. Date: Jul. 4, 2024

(54) SOLID-STATE ELECTROLYTE SYNTHESIS USING A P4SX MATERIAL

(71) Applicant: Solid Power Operating, Inc., Louisville, CO (US)

(72) Inventors: Brian E. Francisco, Arvada, CO (US); Samuel Oberwetter, Lafayette, CO (US); Clint R. Bickmore, Louisville, CO (US)

(21) Appl. No.: 18/389,627

(22) Filed: Dec. 19, 2023

Related U.S. Application Data
(60) Provisional application No. 63/433,708, filed on Dec. 19, 2022.

(51) Int. Cl. C01D 15/00; H01M 10/0562

(52) U.S. Cl. CPC C01D 15/00; H01M 10/0562; C01P 2002/72; H01M 2300/008

(57) ABSTRACT

Described herein are methods for forming solid state electrolyte materials using a compound comprising P₄Sₓ. The methods generally include heating the P₄Sₓ in the presence of one or more lithium compounds to create a solid-state electrolyte.

### CROSS-REFERENCE TO RELATED APPLICATION

This application is related to and claims priority under 35 U.S.C. § 119(e) from U.S. Patent Application No. 63/433,708, filed Dec. 19, 2022, titled “SOLID-STATE ELECTROLYTE SYNTHESIS USING A P₄Sₓ MATERIAL”, the entire contents of which is incorporated by reference herein.

### FIELD OF THE DISCLOSURE

The present disclosure relates to processes for making solid-state electrolyte materials. The disclosure therefore relates to the fields of chemistry, chemical engineering, and electrical engineering.

### BACKGROUND

Sulfide solid state electrolytes such as Li₃PS₄, when exposed to air/moisture, hydrolyze (exchange sulfur for oxygen) and convert into a material such as Li₃PS₄₋ₓOₓ. This reaction generates toxic hydrogen sulfide gas. The incorporation of oxygen diminishes the solid-state electrolyte's ability to conduct lithium ions, thereby decreasing the ionic conductivity of the material. The exposure to air and moisture becomes more prevalent at larger scales of manufacturing as it becomes more challenging and cost prohibitive to dry large quantities of air, solvents, and precursor materials.

What is needed is a process to produce solid state electrolyte materials with low levels of oxygen contamination and high levels of sulfur.

### Summary of Disclosure

Provided herein solid electrolyte materials prepared by heating one or more lithium sources with a compound having the formula P₄Sₓ to form a solid electrolyte material, where 10<x≤40. In some embodiments, the solid electrolyte material is of the formula Li_{(7-y-z)}PS_{(6-y-z)}X_{(y)}W_{(z)}, wherein X and W are individually selected from F, Cl, Br, and I; y and z each individually range from 0 to 2; and wherein y+z ranges from 0 to 2. In some embodiments, the solid electrolyte material is selected from Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, and Li₅PS₄ClBr. In some embodiments, the solid electrolyte material has an X-ray diffraction pattern having peaks corresponding to 2theta of 17.5°±0.5°, 18.1°±0.5°, 19.9°±0.5°, 22.8°±0.5°, 25.95°±0.5°, 29.1°±0.5°, 29.9°+0.5°, and 31.1°+0.5°.

Further provided herein is a process for synthesizing a solid electrolyte material comprising heating one or more lithium sources with a compound having the formula P₄Sₓ to form a solid electrolyte material, where 10<x≤40. In some embodiments, the process further comprises mixing a sulfur source with the one or more lithium sources and the compound having the formula P₄Sₓ. In some embodiments, the compound having the formula P₄Sₓ is amorphous. In some embodiments, the sulfur source containing a phosphorus sulfur material selected from the group consisting of P₄S₃, P₄S₄, P₄S₅, P₄S₆, P₄S₇, P₄S₈, P₄S₉, P₄S₁₀, and combinations thereof. In some embodiments, the one or more lithium source comprises Li₂S, Li₂CO₃, a lithium halide, a lithium pseudohalide, Li₂O, Li₃PO₄, LiBO₂, Li₂B₄O₇, Li₂ZrO₃, LiAIO₂, Li₂TiO₃, LiNbO₃, Li₂SiO₃, or a mixture thereof. In some embodiments, the lithium halide is selected from the group consisting of LiF, LiCl, LiBr, Lil, and mixtures thereof. In some embodiments, the lithium pseudohalide is selected from the group consisting of LiNO₃, LiOH, Li₂SO₃, Li₃N, Li₂NH, LiNH₂, LiBF₄, LiBH₄, and mixtures thereof. In some embodiments, the one or more lithium sources and the P₄Sₓ are heated to a temperature from about 150° C. to about 600° C.

Further provided herein are solid-state batteries containing a positive electrode layer, a negative electrode layer, and a separator layer where the separator layer contains a solid electrolyte material prepared by heating one or more lithium sources with a compound having the formula P₄Sₓ to form a solid electrolyte material, where 10<x≤40. In some embodiments, the negative electrode layer contains a negative electrode active material and a solid electrolyte material prepared by heating one or more lithium sources with a compound having the formula P₄Sₓ to form a solid electrolyte material, where 10<x≤40. In some embodiments, the positive electrode layer contains a positive electrode active material and solid electrolyte material prepared by heating one or more lithium sources with a compound having the formula P₄Sₓ to form a solid electrolyte material, where 10<x≤40. In some embodiments, the solid electrolyte material is of the formula Li_{(7-y-z)}PS_{(6-y-z)}X_{(y)}W_{(z)}, wherein X and W are individually selected from F, Cl, Br, and I; y and z each individually range from 0 to 2; and wherein y+z ranges from 0 to 2. In some embodiments, the solid electrolyte material is selected from Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, and Li₅PS₄ClBr. In some embodiments, the solid electrolyte material has an X-ray diffraction pattern having peaks corresponding to 2theta of 17.5°±0.5°, 18.1°±0.5°, 19.9°±0.5°, 22.8°±0.5°, 25.95°±0.5°, 29.1°±0.5°, 29.9°+0.5°, and 31.1°+0.5°.

### BRIEF DESCRIPTION OF THE FIGURES

FIG. 1 shows a process flow diagram for the processes of the present disclosure.

FIG. 2 shows x-ray diffraction patterns of solid electrolyte materials synthesized in Example 1, Example 2, Comparative Example 1, and Comparative Example 2.

FIG. 3 shows x-ray diffraction patterns of solid electrolyte materials synthesized in Example 1, Example 3, and Comparative Example 3.

### DETAILED DESCRIPTION

Before the present invention is disclosed and described, it is to be understood that this invention is not limited to the particular processes, methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.” The endpoint may also be based on the variability allowed by an appropriate regulatory body, such as the FDA, USP, etc.

In this disclosure, the terms “including,” “containing,” and/or “having” are understood to mean comprising, and are open ended terms.

As used herein, “pseudohalogen” and “pseudohalide” refer to compounds that resemble halogen elements and halide ions in their chemistry. The term “pseudohalogen” and “pseudohalide” may be used interchangeably with “superhalogen” or “superhalide”, respectively.

Described herein are processes for forming solid electrolyte materials using P₄Sₓ as a precursor. The high sulfur content of the P₄Sₓ acts to incorporate sulfur atoms into the solid electrolyte material, thereby reducing the presence of oxygen species in the solid electrolyte material. This may be indicated by analytical methods known in the art (e.g., Fourier-transform infrared spectroscopy to detect P—O and S—O bonds in the electrolyte material, Phosphorus NMR to detect P—O bonds in the electrolyte material, Raman spectroscopy to detect S—O bonds in the electrolyte material, x-ray diffractometry to detect decomposition products that include oxygen species, etc.) and/or a color difference between a solid electrolyte powder material that includes oxygen species and a solid electrolyte powder material made using P₄Sₓ that has a reduced number of oxygen species. The P₄Sₓ may be made by heating phosphorus and sulfur, or by heating a P₄S₁₀₋ₓ material and elemental sulfur at a temperature of about 300° C., where 0≥x≥7. As the melting temperature of pure P₄S₁₀ is around 288° C., it is preferred to have a reaction temperature of about 300° C. to lower kinetic barriers to P₄Sₓ formation, where x>10. Because the P₄Sₓ is made at these high temperatures, the P₄Sₓ does not decompose at the high temperatures required for the synthesis of solid electrolyte materials described herein. Furthermore, the sulfur vapor pressure is significantly lower above P₄Sₓ than above sulfur alone. Considering the creation of P₄Sₓ from a mixture of P₄S₁₀ and sulfur, the temperature preferably increases from the melting point of sulfur through the sequences of sulfur ring opening and cracking, and finally through the melting point of phosphorous sulfide. During this process, sulfur is added to the phosphorus sulfide through a combination reaction. This reaction may be simply described as P₄S₁₀+S=P₄S₁₀+x. As the elemental sulfur ring opening occurs at approximately 160° C. at which point it becomes a liquid, and the long chain sulfur cracking to shorter chains occurs at approximately 250° C. which increases the reactivity of the elemental sulfur, the reactivity of the elemental sulfur material with P₄S₁₀₋ₓ materials may be enhanced such that the reaction temperatures are lowered and the combination reaction proceeds more easily toward completion. Alternatively, the processing temperature may be raised above any of the melting or cracking temperatures described here to enhance mixing. The reaction mechanism is more fully described in Li, Xiaona, et al., “Sulfur-Rich Phosphorus Sulfide Molecules for Use in Rechargeable Lithium Batteries” Angewandte Chemie, Vol. 56 Issue 11, pp. 2937-2941, 2017, the entire contents of which are incorporated by reference herein.

In the present disclosure, P₄Sₓ is used as a precursor material to form solid electrolyte materials, where x is an integer greater than 10. In some embodiments, x may be greater than 40, or 10<x≤40. In other embodiments, P₄Sₓ is used as a precursor material to form solid electrolyte materials, where 10<x≤ 35, 10<x≤ 30, 10<x≤ 25, 10<x≤ 20, 10<x≤ 15, 10<x≤ 14, 10<x≤ 13, 10<x≤ 12, or 10<x≤ 11. In preferred embodiments, 10<x≤ 14. Without wishing to be bound by theory, when 10<x≤14, the P₄Sₓ is a crystalline-phase material with properties more preferred for forming solid electrolyte materials. When x is greater than about 14, the P₄Sₓ is an amorphous phase material due to the large relative quantities of sulfur.

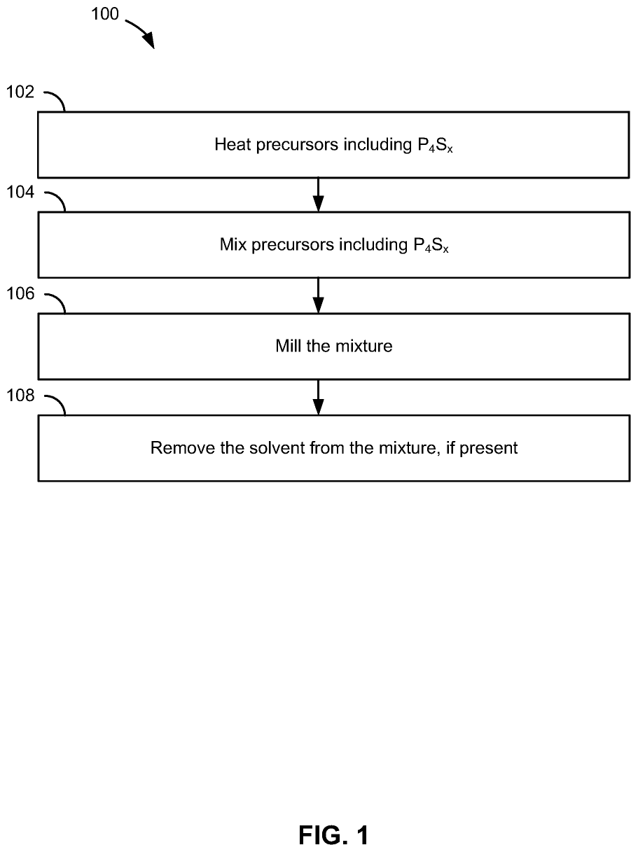

Referring now to FIG. 1, a process 100 of the present disclosure may generally comprise heating the precursors to form the solid electrolyte material. The lithium source and the P₄Sₓ may be individually or collectively referred to herein as “precursors” or “precursor materials”. In one embodiment, the process may further comprise simultaneously mixing the precursors while heating.

The precursors may be heated to a temperature from about 150° C. and about 600 ºC. The precursors may be heated to a temperature from about 150° C. to about 200° C., about 150° ° C. to about 250° C., about 150° ° C. to about 300° C., about 150° C. to about 350° C., about 150° ° C. to about 400° C., about 150° ° C. to about 450° C., about 150° C. to about 500° C., about 150° C. to about 550° C., about 150° ° C. to about 600° C., about 200° C. to about 600° C., about 250° ° C. to about 600° C., about 300° ° C. to about 600° C., about 350° C. to about 600° C., about 400° C. to about 600° C., about 450° ° C. to about 600° C., about 500° C. to about 600° C., about 550° C. to about 600° C., about 200° C. to about 400° C., about 200° ° C. to about 350° C., or about 250° C. to about 350° C. As an example, the composite may be heated in step b) to a temperature of about 150° C., about 175° C., about 200° C., about 225° C., about 250° C., about 275° C., about 300° ° C., about 325° C., about 350° C., about 375° C., about 400° C., about 425° C., about 450° C., about 475° C., about 500° C., about 525° C., about 550° C., about 575° C., or about 600° C. Those having skill in the art will appreciate that the temperature may be limited or adjusted based on factors such as the type of equipment used or the atmospheric pressure.

The process 100 may further include at step 104 mixing precursors including P₄Sₓ in a solvent. The processes may further comprise mixing one or more lithium sources with the compound having the formula P₄Sₓ. The mixing may form a homogeneous composite. As used herein, a “homogeneous composite” is understood to refer to a composite material wherein all or substantially all of the components of the composite material (i.e., the precursors) are approximately evenly distributed throughout the composite material. The mixing may be accomplished by methods generally known in the art. Agitating the mixture during the heat treatment decreases the scale of mixing, thus providing a more homogeneous product. The mixing can be done by a variety of techniques practiced by those skilled in the art. This includes agitators, rotating calciners, high shear mixers, compounders, and agitated media mills. In some embodiments, agitators including agitated media mills, twin screw compounders, and other high shear equipment may be used to mix the materials to form a homogeneous composite.

Exemplary lithium sources may include one or more of Li₂S, Li₂CO₃, a lithium halide, a lithium pseudohalide, Li₂O, Li₃PO₄, LiBO₂, Li₂B₄O₇, Li₂ZrO₃, LiAIO₂, Li₂TIO₃, LiNnO₃, and Li₂SiO₄, or a mixture thereof. Exemplary lithium halides may include one or more of LiF, LiCl, LiBr, and Lil, while exemplary lithium pseudohalides may include LiNO₃, LiOH, Li₂SO₃, Li₃N, Li₂NH, LiNH₂, LiBF₄, LiBH₄ or a mixture thereof.

The mixing may comprise dry mixing or wet mixing. Dry mixing comprises mixing the precursors without the use of one or more solvents; thus, the resulting mixture may be free of a solvent or substantially free of a solvent. Wet mixing comprises mixing the precursors with the use of a solvent. The solvent may be a reactive solvent or a non-reactive solvent. The reactive solvent may include a ketone, ester, aldehyde, amine, nitro, and/or nitrile solvents. The non-reactive solvent may include an alkane, a blend of alkanes, xylene (including para-, meta-, and ortho-xylene), toluene, benzene, heptane, octane, decalin, 1,2,3,4-tetrahydronaphthalene, or combinations thereof.

In embodiments where the mixing comprises wet mixing, the solution comprising the precursors is later dried via methods known in the art (e.g., evaporation) prior to heating the precursors to form the final solid electrolyte material. The drying may be accomplished via evaporation, gravity filtration, vacuum filtration, centrifugation, desiccation, and other methods known in the art.

In some embodiments, the mixing forms a homogenous composite. Mixing the precursors to form a homogeneous composite ensures an even distribution of the precursors, which allows the materials to react in the appropriate ratios. Mixing during the heating step may also help to ensure uniform reaction. Additionally, mixing during the reaction may prevent a buildup of gases. For example, materials such as Li₂CO₃ give off CO₂ and CO. In other embodiments, the gases may include SO, SO₂, H₂S, CS₂, and other gases.

The process 100 may further comprise at step 106 milling mixture of precursors to a desired particle size. The milling may include wet milling or dry milling. The dry milling may be accomplished without the use of a solvent; thus, the milled mixture may be free of any solvent or substantially free of any solvent. The wet milling may be accomplished in the presence of a solvent, such as a reactive solvent or a non-reactant solvent described herein. The precursors may be milled for a predetermined period of time at a predetermined temperature to achieve a desired particle size. The milling may be accomplished using an attritor mill, an autogenous mill, a ball mill, a planetary ball mill, a buhrstone mill, a pebble mill, a rod mill, a semi-autogenous grinding mill, a tower mill, a vertical shaft impactor mill, or other milling apparatuses known in the art. Preferably, the milling is accomplished in a planetary ball mill or an attritor mill.

Mixing time and milling time is not specifically limited as long as it allows for appropriate homogenization and reaction of the precursors to generate the solid electrolyte material. The mixing temperature is also not specifically limited as long as it allows for appropriate mixing and is not so high that a precursor enters the gaseous state or prematurely forms a molten reactive flux as described further herein. The mixing and milling may be accomplished in an inert atmosphere, a moisture-free atmosphere, or an ambient atmosphere.

In embodiments where a solvent is used, the process 100 may include removing the solvent at step 108. The solvent may be removed by various separation methods known in the art, such as evaporation and filtration. In particular embodiments, the solvent may be removed via evaporation, gravity filtration, vacuum filtration, centrifugation, desiccation, and other methods known in the art.

When removing the solvent via evaporation, the milled mixture may be heated to a temperature from about 20° ° C. to about 250° C. Those having skill in the art will appreciate that the optimal temperature for evaporation will depend on the solvent used; e.g., high-molecular weight hydrocarbons will generally require higher temperatures to evaporate. The milled mixture may be heated to a temperature from about 20° C. to about 50° C., about 20° C. to about 100° C., about 20° C. to about 150° C., about 20° C. to about 200° C., about 20° C. to about 250° C., about 50° C. to about 250° C., about 100° C. to about 250° C., about 150° C. to about 250° C., or about 200° C. to about 250° C.

The amount of solvent removed may vary. In some embodiments, all or substantially all of the solvent may be removed from the milled mixture. In other embodiments, about 95%, about 90%, about 85%, about 80%, about 75%, or less than about 75% of the solvent may be removed. In still other embodiments, about 99% to about 75% of the solvent may be removed, such as from about 99% to about 95%, about 99% to about 90%, about 99% to about 85%, about 99% to about 80%, about 99% to about 75%, about 95% to about 75%, about 90% to about 75%, about 85% to about 75%, or from about 80% to about 75% of the solvent may be removed.

In some embodiments, the process 100 may further include mixing a sulfur source with the one or more lithium sources and the P₄Sₓ. Exemplary sulfur sources may include, for example, elemental sulfur, sulfur vapor, a polysulfide, or H₂S gas. Non-limiting examples of polysulfides that may be used as the sulfur source include lithium polysulfide, sodium polysulfide, and potassium polysulfide. In an embodiment, the sulfur source is lithium polysulfide, such as Li₂Sₓ, where x is an integer from 2 to 10. In embodiments where the sulfur source includes sulfur vapor or H₂S gas, the sulfur vapor or H₂S gas may be bubbled through or over the composite as heat is applied and the reaction is taking place. Alternatively, in embodiments where the sulfur source includes elemental sulfur, the elemental sulfur may be added directly to the composite mixture during mixing and/or during milling. Preferably, the elemental sulfur is added during the mixing step.

The precursors may further include a compound containing phosphorus and sulfur in addition to the P₄Sₓ where x>10. Exemplary compounds containing phosphorus and sulfur may include, for example, P₄Sₓ (where x ranges from 3 to 10) and P₂S₅. In an embodiment, phosphorus sulfide (P₄Sₓ) comprises mixtures of P₄Sₓ, where x ranges from 3 to 10, and may be a combination of P₄S₃, P₄S₄, P₄S₅, P₄S₆, P₄S₇, P₄S₈, P₄S₉, P₄S₁₀, and P₄Sₓ where x is a non-integer.

When the precursors further include a compound containing phosphorus and sulfur, the P₄Sₓ where x>10, may provide greater than 0% of the phosphorus used in the solid electrolyte material synthesis. For example, the P₄Sₓ, where x>10, may provide greater than 0%, greater than 5%, greater than 10%, greater than 20%, greater than 30%, greater than 40%, greater than 50%, greater than 60%, greater than 70%, greater than 80%, greater than 90%, or greater than 95% of the phosphorus used in the solid electrolyte material synthesis.

When the precursors further include a compound containing phosphorus and sulfur, the compound containing phosphorus and sulfur may provide greater than 0% of the phosphorus used in the solid electrolyte material synthesis. For example, the compound containing phosphorus and sulfur may provide greater than 0%, greater than 5%, greater than 10%, greater than 20%, greater than 30%, greater than 40%, greater than 50%, greater than 60%, greater than 70%, greater than 80%, greater than 90%, or greater than 95% of the phosphorus used in the solid electrolyte material synthesis.

The molar ratio of phosphorus to lithium to sulfur (P:Li:S) may be selected such that the reaction produces a desired solid electrolyte material. The molar amount of phosphorus in the molar ratio may be selected from 1 about to about 4, such as from about 1 to about 2, from about 1 to about 3, from about 2 to about 3, from about 2 to about 4, or from about 3 to about 4. In some examples, the molar amount of phosphorus in the molar ratio may be 1, 1.5, 2, 2.5, 3, 3.5, or 4. The molar amount of lithium in the molar ratio may be selected from about 1 to about 9, such as from about 1 to about 3, from about 1 to about 5, from about 1 to about 7, from about 3 to about 5, from about 3 to about 7, from about 3 to about 9, from about 5 to about 7, from about 5 to about 9, or from about 7 to about 9. In some examples, the molar amount of lithium in the molar ratio may be 1, 1.5, 2, 2.5, 3, 3.5, 4, 4.5, 5, 5.5, 6, 6.5, 7, 7.5, 8, 8.5, or 9. The molar amount of sulfur in the molar ratio may be selected from about 3 to about 12, such as from about 3 to about 6, from about 3 to about 9, from about 3 to about 12, from about 6 to about 9, from about 6 to about 12, or from about 9 to about 12. In some examples, the molar amount of sulfur in the molar ratio may be 3, 3.5, 4, 4.5, 5, 5.5, 6, 6.5, 7, 7.5, 8, 8.5, 9, 9.5, 10, 10.5, 11, 11.5, 12, 12.5, or 13. Thus, the molar ratio of phosphorus to lithium to sulfur may be 1-4:1-9:3-12. Preferably, sulfur is added in molar excess compared to phosphorus and lithium.

As non-limiting examples, the molar ratio of phosphorus to lithium to sulfur used in the process may be according to the following reaction formulas. Although the reactions are shown as stoichiometric equivalents, those having ordinary skill in the art will appreciate that one or more precursors may be provided in molar excess.

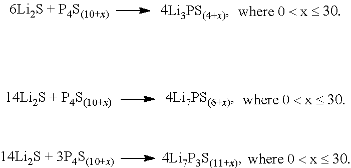

The processes described herein may be used to prepare a solid electrolyte material of the formula Li_{(7-y-z)}PS_{(6-y-z)}X_{(y)}W_{(z)} (where X and W are each individually selected from F, Cl, Br, and I, y and z range from 0 to 2, and wherein y+z ranges from 0 to 2. Exemplary solid electrolyte materials prepared by the process described herein may include, for example, Li₃PS₄, Li₄P₂S₆, Li_{5.5}PS_{4.5}Cl_{1.5}, Li_{5.5}PS_{4.5}ClBr_{0.5}, Li₅PS₄Cl₂, Li₅PS₄ClBr, and Li₇P₃S₁₁. The solid electrolyte material may be a crystalline glassy-ceramic.

The solid electrolyte prepared by the processes of the present disclosure may include Li_{5.5}PS_{4.5}Cl_{1.5}. The solid electrolyte may have an X-ray diffraction pattern with peaks corresponding to 2theta of 17.5°±0.5°, 18.1°±0.5°, 19.9°±0.5°, 22.8°±0.5°, 25.95°±0.5°, 29.1°±0.5°, 29.9°±0.5°, 31.1°±0.5°.

The process described herein may further be used to prepare an oxysulfide solid electrolyte material of the formula Li_{(7-y-z)}PS_{(6-y-z-u)}OᵤX_{(y)}W_{(z)} where X and W are each individually selected from F, Cl, Br, and I, y and z range from 0 to 2, u ranges from about 0 to about 6, and wherein y+z ranges from 0 to 2. Exemplary oxysulfide solid electrolyte materials prepared by the process described herein may include, for example, Li₃PS_{3.9}O_{0.1}, Li₃PS_{3.5}O_{0.5}, Li₆PS_{4.8}O_{0.3}Cl, Li₆PS_{4.7}O_{0.3}Br, Li_{5.5}PS_{4.1}O_{0.4}Cl_{1.5}, and Li_{5.5}PS_{3.5}OClBr_{0.5}.

### Enumerated Embodiments

Embodiment 1: A process for synthesizing a solid electrolyte material comprising: heating one or more lithium sources with a compound having the formula P₄Sₓ to form a solid electrolyte material, wherein x is an integer greater than 10.

Embodiment 2: The process of embodiment 1, wherein 10<x≤40.

Embodiment 3: The process of embodiment 1, wherein 10<x≤14.

Embodiment 4: The process of any one of embodiments 1-3, wherein the P₄Sₓ is crystalline.

Embodiment 5: The process of any one of embodiments 1-3, wherein the P₄Sₓ is amorphous.

Embodiment 6: A process for synthesizing a solid electrolyte material comprising: heating one or more lithium sources with a compound having the formula P₄Sₓ to form a solid electrolyte material, where 10<x≤40.

Embodiment 7: The process of embodiment 6, further comprising mixing a sulfur source with the one or more lithium sources and the compound having the formula P₄Sₓ.

Embodiment 8: The process of embodiment 7, wherein the one or more lithium source comprises Li₂S, Li₂CO₃, a lithium halide, a lithium pseudohalide, Li₂O, Li₃PO₄, LiBO₂, Li₂B₄O₇, Li₂ZrO₃, LiAIO₂, Li₂TiO₃, LiNbO₃, Li₂SiO₃, or a mixture thereof.

Embodiment 9: The process of embodiment 6, wherein the one or more lithium source comprises Li₂S, Li₂CO₃, a lithium halide, a lithium pseudohalide, Li₂O, Li₃PO₄, LiBO₂, Li₂B₄O₇, Li₂ZrO₃, LiAIO₂, Li₂TIO₃, LiNbO₃, Li₂SiO₃, or a mixture thereof.

Embodiment 10: The process of embodiment 9, wherein the lithium halide is selected from the group consisting of LiF, LiCl, LiBr, Lil, and mixtures thereof.

Embodiment 11: The process of embodiment 9, wherein the lithium pseudohalide is selected from the group consisting of LiNO₃, LiOH, Li₂SO₃, Li₃N, Li₂NH, LiNH₂, LiBF₄, LiBH₄, and mixtures thereof.

Embodiment 12: The process of any one of embodiments 6-11, further comprising simultaneously mixing the one or more lithium sources and the compound having the formula P₄Sₓ while heating.

Embodiment 13: The process of any one of embodiments 6-12, wherein the solid electrolyte is a crystalline glassy-ceramic.

Embodiment 14: The process of any one of embodiments 6-13, wherein the solid electrolyte comprises Formula (I):

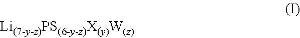

wherein:
X and W are individually selected from F, Cl, Br, and I;
y and z each individually range from 0 to 2; and
wherein y+z ranges from 0 to 2.

Embodiment 15: The process of embodiment 14, wherein the solid electrolyte of Formula (I) is selected from Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, and Li₅PS₄ClBr.

Embodiment 16: The process of any one of embodiments 6-15, further comprising mixing or milling the one or more lithium sources with the P₄Sₓ to form a homogeneous composite prior to the heating.

Embodiment 17: The process of embodiment 6, wherein the lithium source comprises Li₂CO₃.

Embodiment 18: The process of embodiment 6, wherein the lithium source comprises two lithium sources including Li₂CO₃ and LiCl.

Embodiment 19: The process of any one of embodiments 6-18, wherein the one or more lithium sources and the P₄Sₓ are heated to a temperature from about 150° C. to about 600° C.

Embodiment 20: The process of any one of embodiments 6-19, wherein the heating further comprises heating a compound containing phosphorus and sulfur.

Embodiment 21: The process of embodiment 20, wherein the compound containing phosphorus and sulfur is selected from the group consisting of P₄S₃, P₄S₄, P₄S₅, P₄S₆, P₄S₇, P₄S₈, P₄S₉, P₄S₁₀, and combinations thereof.

Embodiment 22: The process of embodiment 16, further comprising mixing or milling a compound containing phosphorus and sulfur with the one or more lithium sources and with the P₄Sₓ to form the homogeneous composite prior to the heating.

Embodiment 23: The process of embodiment 22, wherein the compound containing phosphorus and sulfur is selected from the group consisting of P₄S₃, P₄S₄, P₄S₅, P₄S₆, P₄S₇, P₄S₈, P₄S₉, P₄S₁₀, and combinations thereof.

Embodiment 24: A solid electrolyte material prepared by the process of any one of embodiments 1-23, wherein the solid electrolyte material is of Formula (I):

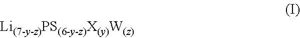

wherein:
X and W are individually selected from F, Cl, Br, and I;
y and z each individually range from 0 to 2; and
y+z ranges from 0 to 2.

Embodiment 25: The solid electrolyte material of embodiment 24, wherein the solid electrolyte material of Formula (I) is selected from Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, and Li₅PS₄ClBr.

Embodiment 26: A process for synthesizing a solid electrolyte material comprising: mixing one or more lithium sources with a compound having the formula P₄Sₓ to form a homogeneous composite, where 10<x≤40; and heating the homogeneous composite to form the solid electrolyte.

Embodiment 27: A process for synthesizing a solid electrolyte material comprising: mixing one or more lithium sources with a compound having the formula P₄Sₓ to form a homogeneous composite, where 10<x≤40; and milling the mixture; and heating the homogeneous composite to form the solid electrolyte.

Embodiment 28: A process for synthesizing a solid electrolyte material comprising: dissolving precursors comprising one or more lithium sources and a compound having the formula P₄Sₓ in a solvent, where 10<x≤40; removing the solvent; and heating the precursors to form the solid electrolyte.

Embodiment 29: A composition comprising one or more precursors and a compound having the formula P₄Sₓ in a solvent, wherein 10<x≤40.

Embodiment 30: The composition of embodiment 29, wherein 10<x≤14.

Embodiment 31: The composition of embodiment 29, wherein the P₄Sₓ is crystalline.

Embodiment 32: The composition of embodiment 29, wherein the P₄Sₓ is amorphous.

Embodiment 33: The composition of any one of embodiments 29-32, wherein the one or more precursors comprises one or more lithium sources, a sulfur source, or a combination thereof.

Embodiment 34: A solid electrolyte material prepared by heating one or more lithium sources with a compound having the formula P₄Sₓ to form a solid electrolyte material, where 10<x≤40.

Embodiment 35: The solid electrolyte material of embodiment 34, wherein the solid electrolyte material is of the formula:

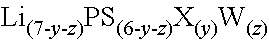

where:
X and W are individually selected from F, Cl, Br, and I;
y and z each individually range from 0 to 2; and
y+z ranges from 0 to 2.

Embodiment 36: The solid electrolyte of embodiment 34 or 35, wherein the solid electrolyte material is selected from Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, and Li₅PS₄ClBr.

Embodiment 37: The solid electrolyte material of any one of embodiments 34-36, wherein the solid electrolyte material contains one solid electrolyte material of the formula: Li_{(7-y-z)}PS_{(6-y-z)}X_{(y)}W_{(z)} wherein: X and W are individually selected from F, Cl, Br, and I; y and z each individually range from 0 to 2; and y+z ranges from 0 to 2, and contains at least one solid electrolyte material selected from Li₃PS₄, Li₄P₂S₆, and Li₇P₃S₁₁.

Embodiment 38: The solid electrolyte material of any one of embodiments 34-37, wherein the solid electrolyte material has an X-ray diffraction pattern having peaks corresponding to 2theta of 17.5°±0.5°, 18.1°±0.5°, 19.9°±0.5°, 22.8°±0.5°, 25.95°±0.5°, 29.1°±0.5°, 29.9°+0.5°, and 31.1°±0.5°.

Embodiment 39: A process for synthesizing a solid electrolyte material comprising: heating one or more lithium sources with a compound having the formula P₄Sₓ to form a solid electrolyte material, where 10<x≤ 40.

Embodiment 40: The process of embodiment 39, further comprising mixing a sulfur source with the one or more lithium sources and the compound having the formula P₄Sₓ.

Embodiment 41: The process of embodiment 39 or embodiment 40, wherein the compound having the formula P₄Sₓ is amorphous.

Embodiment 42: The process of embodiment 40, wherein the sulfur source containing a phosphorus sulfur material selected from the group consisting of P₄S₃, P₄S₄, P₄S₅, P₄S₆, P₄S₇, P₄S₈, P₄S₉, P₄S₁₀, and combinations thereof.

Embodiment 43: The process of any one of embodiments 39-42, wherein the one or more lithium source comprises Li₂S, Li₂CO₃, a lithium halide, a lithium pseudohalide, Li₂O, Li₃PO₄, LiBO₂, Li₂B₄O₇, Li₂ZrO₃, LiAIO₂, Li₂TIO₃, LiNbO₃, Li₂SiO₃, or a mixture thereof.

Embodiment 44: The process of embodiment 43, wherein the lithium halide is selected from the group consisting of LiF, LiCl, LiBr, Lil, and mixtures thereof.

Embodiment 45: The process of any one of embodiments 43 or 44, wherein the lithium pseudohalide is selected from the group consisting of LiNO₃, LiOH, Li₂SO₃, Li₃N, Li₂NH, LiNH₂, LiBF₄, LiBH₄, and mixtures thereof.

Embodiment 46: The process of any one of embodiments 39-45, wherein the one or more lithium sources and the P₄Sₓ are heated to a temperature from about 150° C. to about 600° C.

Embodiment 47: A solid-state battery containing a positive electrode layer, a negative electrode layer, and a separator layer where the separator layer contains a solid electrolyte material prepared by heating one or more lithium sources with a compound having the formula P₄Sₓ to form a solid electrolyte material, where 10<x≤40.

Embodiment 48: The solid-state battery of embodiment 47, wherein the negative electrode layer contains a negative electrode active material and a solid electrolyte material prepared by heating one or more lithium sources with a compound having the formula P₄Sₓ to form a solid electrolyte material, where 10<x≤40.

Embodiment 49: The solid-state battery of embodiment 47, wherein the positive electrode layer contains a positive electrode active material and solid electrolyte material prepared by heating one or more lithium sources with a compound having the formula P₄Sₓ to form a solid electrolyte material, where 10<x≤40.

Embodiment 50: The solid-state battery of any one of embodiments 47-49, wherein the solid electrolyte material solid electrolyte material is of the formula:

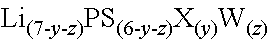

wherein:
X and W are individually selected from F, Cl, Br, and I;
y and z each individually range from 0 to 2; and
y+z ranges from 0 to 2.

Embodiment 51: The solid-state battery of any one of embodiments 47-49, wherein the solid electrolyte material solid electrolyte material is selected from Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, and Li₅PS₄ClBr.

Embodiment 52: The solid-state battery of any one of embodiments 47-49, wherein the solid electrolyte material contains one solid electrolyte material of the formula: Li_{(7-y-z)}PS_{(6-y-z)}X_{(y)}W_{(z)} wherein: X and W are individually selected from F, Cl, Br, and I; y and z each individually range from 0 to 2; and where y+z ranges from 0 to 2, and contains at least one solid electrolyte material selected from Li₃PS₄, Li₄P₂S₆, and Li₇P₃S₁₁.

Embodiment 53: The solid-state battery of any one of embodiments 47-52, wherein the solid electrolyte material has an X-ray diffraction pattern having peaks corresponding to 2theta of 17.5°±0.5°, 18.1°±0.5°, 19.9°±0.5°, 22.8°±0.5°, 25.95°±0.5°, 29.1°±0.5°, 29.9°±0.5°, and 31.1°±0.5.

### EXAMPLES

### Example 1: Synthesis of a Li_{5.5}PS_{4.5}Cl_{1.5} Solid Electrolyte Material Using a P₄Sₓ Material

First, a P₄Sₓ material was created by treating 30 g P₄S₁₀ and 2.25 g elemental sulfur in a sealed vessel for 20 hrs at 300° C. The result of this process was a crystalline material with the nominal composition P₄S₁₁. 10.7191 g of the P₄S₁₁ material was then combined with 8.4406 g Li₂S and 5.8403 g LiCl and loaded into a 250 ml zirconia planetary milling jar with 400 g zirconia media. 92 g of heptane was added, and the jar was sealed and milled for 3 hr at 500 rpm. The material resulting from this milling process was recovered by removing the heptane under vacuum at 90° C. Finally, the dried material was subjected to heat treatment for 30 min at 450° C. In this recipe a stoichiometric amount of phosphorus was utilized.

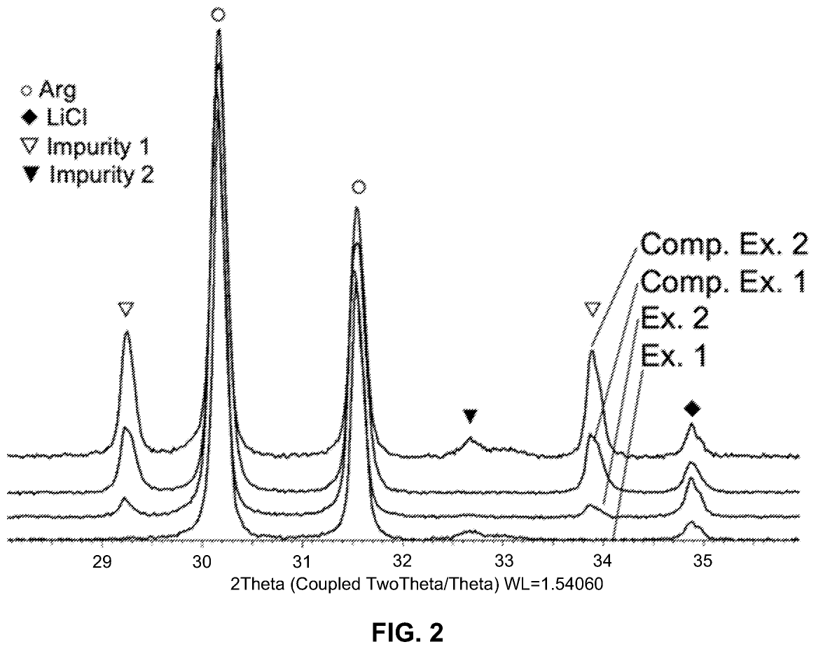

From the XRD patterns (FIG. 2), it can be observed that Example 1 is a composite containing the electrolyte phase of Li_{5.5}PS_{4.5}Cl_{1.5} and unreacted LiCl. The Li_{5.5}PS_{4.5}Cl_{1.5} has peaks at 2theta=30.1°, and 31.6°. The LiCl has a peak at 34.9°.

### Example 2: Synthesis of a Li_{5.5}PS_{4.5}Cl_{1.5} Solid Electrolyte Material Using a P₄Sₓ Material

First, a P₄Sₓ material was created by treating 30 g P₄S₁₀ and 2.25 g elemental sulfur in a sealed vessel for 20 hrs at 300° C. The result of this process was a crystalline material with the nominal composition P₄S₁₁. 10.4309 g of the P₄S₁₁ material was then combined with 8.6073 g Li₂S and 5.9618 g LiCl and loaded into a 250 ml zirconia planetary milling jar with 400 g zirconia media. 92 g of heptane was added, and the jar was sealed and milled for 3 hr at 500 rpm. The material resulting from this milling process was recovered by removing the heptane under vacuum at 90° C. Finally, the dried material was subjected to heat treatment for 30 min at 450° C. In this recipe, a mass of phosphorus-containing precursor was used that was equivalent to a mass of P₄S₁₀ in a typical synthesis, such as that of Comparative Example 1 described below.

From the XRD patterns (FIG. 2), it can be observed that Example 2 is a composite containing the electrolyte phase of Li_{5.5}PS_{4.5}Cl_{1.5}, Impurity 1, and unreacted LiCl. The Li_{5.5}PS_{4.5}Cl_{1.5} has peaks at 2theta=30.1°, and 31.6°. The Impurity 1 has peaks at 29.25°, and 33.9°. The LiCl has a peak at 34.9°.

### Comparative Example 1: Synthesis of a Li_{5.5}PS_{4.5}Cl_{1.5} Solid Electrolyte Material Using a P₄S₁₀ Material

Starting materials including 10.4311 g P₄S₁₀, 8.6078 g Li₂S and 5.9626 g LiCl were combined and loaded into a 250 ml zirconia planetary milling jar with 400 g zirconia media. 92 g of heptane was added, and the jar was sealed and milled for 3 hr at 500 rpm. The material resulting from this milling process was recovered by removing the heptane under vacuum at 90° C. Finally, the dried material was subjected to heat treatment for 30 min at 450° C. In this recipe a stoichiometric amount of phosphorus was utilized.

From the XRD patterns (FIG. 2), it can be observed that Comparative Example 1 is a composite containing the electrolyte phase of Li_{5.5}PS_{4.5}Cl_{1.5}, Impurity 1, and unreacted LiCl. The Li_{5.5}PS_{4.5}Cl_{1.5} has peaks at 2theta=30.1º, and 31.6°. The Impurity 1 has peaks at 29.25°, and 33.9°. The LiCl has a peak at 34.9°.

### Comparative Example 2: Synthesis of a Li_{5.5}PS_{4.5}Cl_{1.5} Solid Electrolyte Material Using an Excess of a P₄S₁₀ Material

Starting materials including 10.9524 g P₄S₁₀, 8.6073 g Li₂S and 5.9618 g LiCl were combined and loaded into a 250 ml zirconia planetary milling jar with 400 g zirconia media. 92 g of heptane was added, and the jar was sealed and milled for 3 hr at 500 rpm. The material resulting from this milling process was recovered by removing the heptane under vacuum at 90° C. Finally, the dried material was subjected to heat treatment for 30 min at 450° C. In this recipe an excess amount of P₄S₁₀ is utilized as a method to incorporate excess sulfur.

From the XRD patterns (FIG. 2), it can be observed that Comparative Example 2 is a composite containing the electrolyte phase of Li_{5.5}PS_{4.5}Cl_{1.5}, Impurity 1, Impurity 2, and unreacted LiCl. The Li_{5.5}PS_{4.5}Cl_{1.5} has peaks at 2theta=30.1°, and 31.6°. The Impurity 1 has peaks at 29.25°, and 33.9°. The Impurity 2 has a peak at 32.7°. The LiCl has a peak at 34.9°.

### Comparative Example 3: Synthesis of a Li_{5.5}PS_{4.5}Cl_{1.5} Solid Electrolyte Material Using a P₄S₁₀ Material Subjected to a Pre-treatment

First, a P₄S₁₀ material is treated in a sealed vessel for 20 hrs at 300° C. 10.4309 g of the treated P₄S₁₀ material was then combined with 8.6073 g Li₂S and 5.9618 g LiCl and loaded into a 250 ml zirconia planetary milling jar with 400 g zirconia media. 92 g of heptane was added, and the jar was sealed and milled for 3 hr at 500 rpm. The material resulting from this milling process was recovered by removing the heptane under vacuum at 90° C. Finally, the dried material was subjected to heat treatment for 30 min at 450° C.

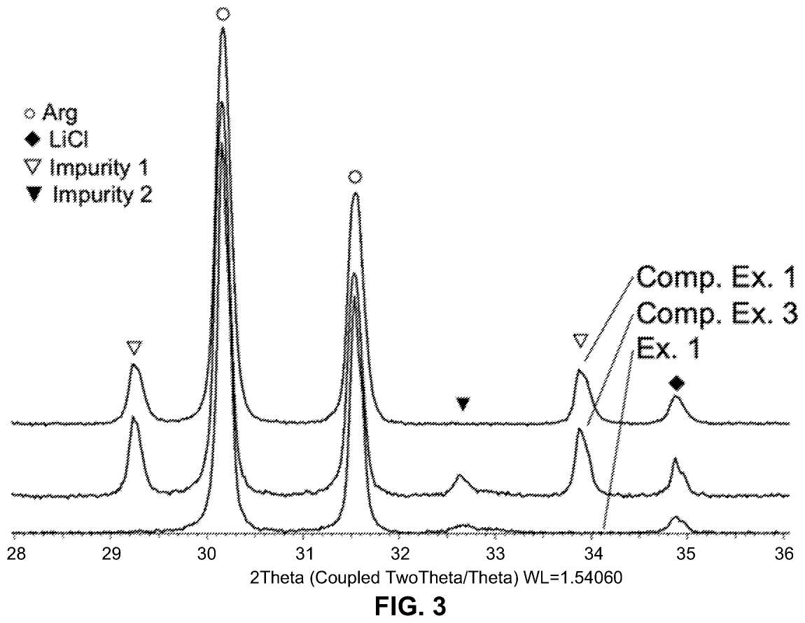

From the XRD patterns (FIG. 3), it can be observed that Comparative Example 3 is a composite containing the electrolyte phase of Li_{5.5}PS_{4.5}Cl_{1.5}, Impurity 1, Impurity 2, and unreacted LiCl. The Li_{5.5}PS_{4.5}Cl_{1.5} has peaks at 2theta=30.1°, and 31.6°. The Impurity 1 has peaks at 29.25°, and 33.9°. The Impurity 2 has a peak at 32.7°. The LiCl has a peak at 34.9°.

X-ray diffraction patterns of the materials produced in the Examples and Comparative Examples above are shown in FIGS. 2 and 3. The X-ray diffraction patterns identify an argyrodite phase (Arg) solid electrolyte material, LiCl, and two impurities.

Impurity #1 may be a material comprising P₂S₆ and/or P₂S₇ structural features. Knowing that Argyrodite-type materials contain only PS₄ structural features, it can be understood that the presence of P₂S₆ and/or P₂S₇ is an indication of sulfur-deficiency. Therefore, the present invention provides processes for correcting for any sulfur deficiency, which leads to higher phase purity in a resultant electrolyte.

Impurity #2 may be Li₄P₂S₆, a Li₄P₂S₆-like material, or a material comprising P₂S₆ and/or P₂S₇ structural features. Knowing that Argyrodite-type materials contain only PS₄ structural features, it can be understood that the presence of a Li₄P₂S₆-like material, P₂S₆ and/or P₂S₇ is an indication of sulfur-deficiency. Therefore, the present invention provides processes for correcting for any sulfur deficiency, which leads to higher phase purity in a resultant electrolyte.

X-ray diffraction patterns of the materials synthesized in Examples 1-2 and Comparative Examples 1-2 are shown in FIG. 2. An argyrodite phase solid electrolyte material was identified. It can be seen when comparing Example 1 to Comparative Example 1 that pretreating a P₄S₁₀ material with elemental sulfur before using the P₄S₁₀ material for synthesis resulted in an electrolyte with lower levels of impurities. Additionally, comparing Example 1 to Example 2, it can be seen that compensating for the altered phosphorus-to-sulfur ratio of a P₄Sₓ material is important to achieving improved purity.

Comparing Example 1 to Comparative Example 2, it can be seen that incorporating extra sulfur by using an excess of P₄S₁₀ does not lead to improved purity.

X-ray diffraction patterns of the materials synthesized in Example 1 and Comparative Examples 1 and 3 are shown in FIG. 3. These patterns show the effect of pre-treating a P₄S₁₀ material with elemental sulfur. If a P₄S₁₀ material is subjected to a heat treatment without elemental sulfur, such as in Comparative Example 3, purity is not improved when compared to pre-treating the P₄S₁₀ material with elemental sulfur to first create a P₄Sₓ material.

Commercially available P₄S₁₀ material can be understood to be a mixture comprising P₄S₁₀, P₄S₁₀₋ₓ, and sulfur, where “x” can typically vary from 1 to 3. Without wishing to be bound by theory, certain reactions or processing methods which require P₄S₁₀ may not be able to successfully utilize non-P₄S₁₀ materials, such as P₄S₁₀₋ₓ or elemental sulfur, which may lead to a sulfur deficiency in reaction products or solid electrolytes made therewith. Therefore, it is beneficial to ensure full sulfur availability by ensuring that at least a required amount of sulfur is compounded with other elements rather than existing in elemental form. It is also possible and potentially beneficial to provide an excess of sulfur by first creating a compound such as P₄Sₓ or Li₂Sₓ. The excess sulfur may act to ensure that the required amount of sulfur is provided to the reaction while also preventing the formation of undesired oxygen-containing compounds which may otherwise form due to reactant material contamination or incidental air intrusion during processing.

What is claimed is:

1. A solid electrolyte material prepared by heating one or more lithium sources with a compound having the formula P₄Sₓ to form a solid electrolyte material, where 10<x≤40.

2. The solid electrolyte material of claim 1, wherein the solid electrolyte material is of the formula: 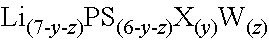
wherein:
X and W are individually selected from F, Cl, Br, and I;
y and z each individually range from 0 to 2; and
where y+z ranges from 0 to 2.

3. The solid electrolyte of claim 1, wherein the solid electrolyte material is selected from Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, and Li₅PS₄ClBr.

4. The solid electrolyte material of claim 1, wherein the solid electrolyte material contains one solid electrolyte material of the formula: Li_{(7-y-z)}PS_{(6-y-z)}X_{(y)}W_{(z)} wherein: X and W are individually selected from F, Cl, Br, and I; y and z each individually range from 0 to 2; and y+z ranges from 0 to 2, and contains at least one solid electrolyte material selected from Li₃PS₄, Li₄P₂S₆, and Li₇P₃S₁₁.

5. The solid electrolyte material of claim 1, wherein the solid electrolyte material has an X-ray diffraction pattern having peaks corresponding to 2theta of 17.5°±0.5°, 18.1°±0.5°, 19.9°±0.5°, 22.8°±0.5°, 25.95°±0.5°, 29.1°±0.5°, 29.9°±0.5°, and 31.1°±0.5°.

6. A process for synthesizing a solid electrolyte material comprising
heating one or more lithium sources with a compound having the formula P₄Sₓ to form a solid electrolyte material, where 10<x≤40.

7. The process of claim 6, further comprising mixing a sulfur source with the one or more lithium sources and the compound having the formula P₄Sₓ.

8. The process of claim 6, wherein the compound having the formula P₄Sₓ is amorphous.

9. The process of claim 6, wherein the sulfur source containing a phosphorus sulfur material selected from the group consisting of P₄S₃, P₄S₄, P₄S₅, P₄S₆, P₄S₇, P₄S₈, P₄S₉, P₄S₁₀, and combinations thereof.

10. The process of claim 6, wherein the one or more lithium source comprises Li₂S, Li₂CO₃, a lithium halide, a lithium pseudohalide, Li₂O, Li₃PO₄, LiBO₂, Li₂B₄O₇, Li₂ZrO₃, LiAIO₂, Li₂TIO₃, LiNbO₃, Li₂SiO₃, or a mixture thereof.

11. The process of claim 6, wherein the lithium halide is selected from the group consisting of LiF, LiCl, LiBr, Lil, and mixtures thereof.

12. The process of claim 6, wherein the lithium pseudohalide is selected from the group consisting of LiNO₃, LiOH, Li₂SO₃, Li₃N, Li₂NH, LiNH₂, LiBF₄, LiBH₄, and mixtures thereof.

13. The process of claim 6, wherein the one or more lithium sources and the P₄Sₓ are heated to a temperature from about 150° C. to about 600° C.

14. A solid-state battery containing a positive electrode layer, a negative electrode layer, and a separator layer where the separator layer contains a solid electrolyte material prepared by heating one or more lithium sources with a compound having the formula P₄Sₓ to form a solid electrolyte material, where 10<x≤40.

15. The solid-state battery of claim 14, wherein the negative electrode layer contains a negative electrode active material and a solid electrolyte material prepared by heating one or more lithium sources with a compound having the formula P₄Sₓ to form a solid electrolyte material, where 10<x≤40.

16. The solid-state battery of claim 14, wherein the positive electrode layer contains a positive electrode active material and solid electrolyte material prepared by heating one or more lithium sources with a compound having the formula P₄Sₓ to form a solid electrolyte material, where 10<x≤40.

17. The solid-state battery of claim 14, wherein the solid electrolyte material solid electrolyte material is of the formula: 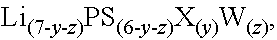
where:
X and W are individually selected from F, Cl, Br, and I;
y and z each individually range from 0 to 2; and
y+z ranges from 0 to 2.

18. The solid-state battery of claim 14, wherein the solid electrolyte material solid electrolyte material is selected from Li₃PS₄, Li₄P₂S₆, Li₇P₃S₁₁, Li_{5.5}PS_{4.5}Cl_{1.5}, Li_{5.5}PS_{4.5}ClBr_{0.5}, Li₅PS₄Cl₂, and Li₅PS₄ClBr.

19. The solid-state battery of claim 14, wherein the solid electrolyte material contains one solid electrolyte material of the formula: Li_{(7-y-z)}PS_{(6-y-z)}X_{(y)}W_{(z)} where: X and W are individually selected from F, Cl, Br, and I; y and z each individually range from 0 to 2; and y+z ranges from 0 to 2, and contains at least one solid electrolyte material selected from Li₃PS₄, Li₄P₂S₆, and Li₇P₃S₁₁.

20. The solid-state battery of claim 14, wherein the solid electrolyte material has an X-ray diffraction pattern having peaks corresponding to 2theta of 17.5°±0.5°, 18.1°±0.5°, 19.9°+0.5°, 22.8°±0.5°, 25.95°±0.5°, 29.1°±0.5°, 29.9°+0.5°, and 31.1°±0.5.
